(19) United States
(12) Patent Application Publication
(10) Pub. No.: US 2004/0119336 A1
(43) Pub. Date: Jun. 24, 2004

(54) Adjusting track tension system for industrial tracks

(75) Inventor: Alain Lussier, St-Francois-Xavier-De-Brompton (CA)

Correspondence Address: AKERMAN SENTERFITT, P.O. BOX 3188, WEST PALM BEACH, FL, 33402-3188, US

(73) Assignee: Camoplast Inc., Sherbrooke (CA)

(21) Appl. No.: 10/700,945

(22) Filed: Oct. 31, 2003

(30) Foreign Application Priority Data
Dec. 23, 2002 (CA) 2,415,005

(51) Int. Cl. B62D 55/14

(52) U.S. Cl. 305/145

(57) ABSTRACT

A track tensioning system comprising a dynamic member supporting a sprocket of a tracked wheel of a tracked vehicle, in such a way that the dynamic member is forced against the track so as to maintain a constant tension thereof in spite of an elastic stretch thereof due to the motion of the tracked vehicle.

### FIELD OF THE INVENTION

The present invention relates to track tensioning systems. More specifically, the present invention is concerned with an adjustable track tensioning system.

### BACKGROUND OF THE INVENTION

It is a well-known fact that the tension of the track of a tracked vehicle varies while the tracked vehicle operates on a rough terrain or under otherwise severe conditions.

Generally, two types of track tensioning systems are used to alleviate this problem. On the first hand, fixed idler systems provide that an idler wheel, rigidly mounted to the frame of the tracked vehicle, be initially adjusted for a desired static tension. On the other hand, movable idle systems use a track tensioning idler wheel connected to the tracked vehicle in such a way as to allow adjustment to a desired static tension so that a uniform total periphery is maintained around the track-contacting elements, comprising the road wheels, the final drive sprocket, the return rollers and the tensioning idler.

Therefore, there is a need in the art for a tensioning system that allows adjusting the tension of the track without stopping the vehicle and modifying the arrangement of bolts on the frame thereof.

### OBJECTS OF THE INVENTION

An object of the present invention is therefore to provide an improved track tensioning system.

### SUMMARY OF THE INVENTION

The present invention provides a track tensioning system for a tracked vehicle including a hull supporting a plurality of mid rollers, a front idler wheel, a rear idler wheel, an idler wheel, a drive sprocket, and an endless track belt trained around the mid rollers, the idler wheels and the drive sprocket, the mid rollers and the idler wheels being mounted on a rail, comprising: a cam plate, rotatably connected to the drive sprocket on a first end thereof, and a member, mounted at a first end thereof to the rail and at a second end thereof to the cam plate; wherein said member has a variable length defined between an attachment point to the cam plate and an attachment point to the rail.

Moreover, there is provided a track tensioning system for a tracked vehicle, comprising a cam plate, rotatably connected to a drive sprocket on a first end thereof, and to a rail supporting mid rollers and idler wheels of the tracked vehicle at a second end thereof; and a member, mounted at a first end thereof to the rail and at a second end thereof to the cam plate; wherein the dynamic member has a variable length.

Furthermore, there is provided a track tensioning system for a tracked vehicle comprising a dynamic member supporting a sprocket of a tracked wheel of the tracked vehicle, wherein the dynamic member is forced against an endless track belt of the vehicle so as to maintain a constant tension thereof.

Other objects, advantages and features of the present invention will become more apparent upon reading of the following non-restrictive description of embodiments thereof, given by way of example only with reference to the accompanying drawings.

### BRIEF DESCRIPTION OF THE DRAWING

In the appended drawing:

FIG. 1 is a partial side view of a tracked vehicle showing a track tensioning system according to an embodiment of the present invention; and

FIG. 2 is a section view of a track belt used in the track tensioning system of FIG. 1.

### DESCRIPTION OF EMBODIMENTS OF THE INVENTION

Generally stated, the track tensioning system of the present invention makes comprises a dynamic member supporting a sprocket of a tracked wheel of a tracked vehicle, in such a way that the dynamic member is forced against the track so as to maintain a constant tension thereof in spite of an elastic stretch thereof due to the motion of the tracked vehicle.

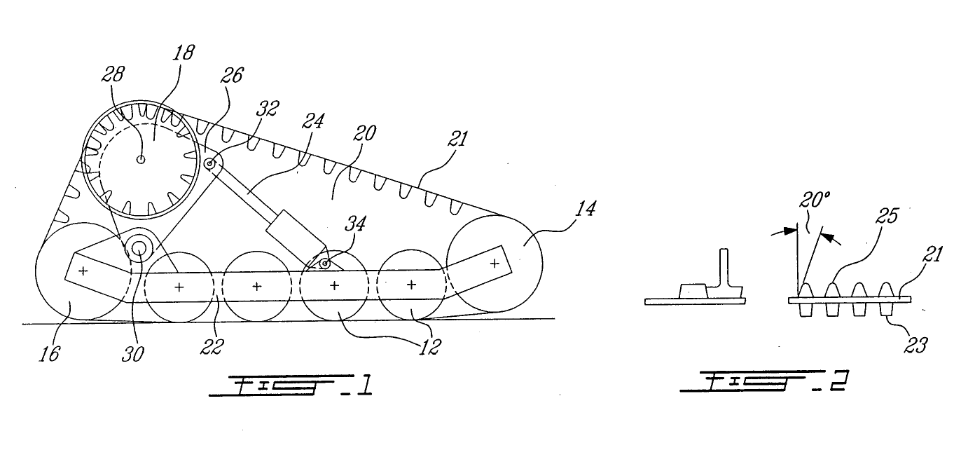

A track tensioning system according to an embodiment of the present invention will be more precisely described in relation of FIG. 1.

A tracked vehicle (only partly shown) comprises a hull 20 supporting a plurality of mid rollers 12, a front idler wheel 14, a rear idler wheel 16, a drive sprocket 18, and an endless track belt 21 trained around the mid rollers 12, the idler wheels 14, 16 and the drive sprocket 18.

The mid rollers 12 and the idler wheels 14, 16 are mounted on a rail 22 in a manner which is believed to be well known in the art and will not be described herein.

The drive sprocket 18 is a drive wheel with teeth for driving the belt 21 in an endless path, by providing that the endless track belt 21 is in driving engagement therewith. The drive sprocket 18 may be mounted on a shaft of a motor or on a chained shaft, as people in the art are well aware of.

The endless drive track 21 is typically formed of resilient material such as rubber, or rubber reinforced to strengthen the track.

As illustrated in FIG. 2, typically, the endless drive track 21 is provided with traction lugs 23 on a first surface thereof, and with drive lugs 25 on a second first surface thereof.

As part of the present invention, variations in the track path length is accommodated by the drive sprocket 18 by the provision of a dynamic member 24, in a way that will be explained hereinbelow.

The dynamic member 24 is mounted at a first end thereof to the rail 22 and at a second end thereof to a cam plate 26, which is rotatably connected to the drive sprocket 18 on the one hand (28), and to the rail 22 on the other end (30).

The dynamic member 24 has a length defined between its attachment point 32 to the cam plate 26 and its attachment point 34 to the rail 22, which is variable, so as to accommodate for variations in the track path length.

The dynamic member 24 may be a spring, a hydraulic cylinder or a pneumatic cylinder, for example.

Interestingly, the track tensioning system of the present invention allows maintaining a constant tension of the track during the motion of the tracked vehicle, including operation on adverse ground surfaces or sudden stops.

Moreover, the track tensioning system of the present invention allows a fine tuning of the tension since it is not limited by design features such as a distance between bolting holes in the frame of the vehicle for example, i.e. the present tensioning system, in sharp contrast with known tensioning systems, is not based on a complex cooperation of parts of the frame of the vehicle bolted together.

Furthermore, the track tensioning system of the present invention allows an increased tolerance in relation to the tuning of the track tension, which may prove to be of a particular interest when operating the track vehicle in areas remote from maintenance facilities. Generally, the present track tensioning system simplifies a rapid rough tension adjustment.

People in the art will appreciate that the track tensioning system of the present invention solves a number of problems recurrent in the art, such as a gradually increasing deformation of the track due to its elasticity, known in the art as ratcheting; drive lugs 25 jumping over the sprocket; and derailing, which may otherwise occur when the track is stretched under a sudden increase of tension due to adverse operating conditions or to a sudden stop of the tracked vehicle.

Although the present invention has been described hereinabove by way of embodiments thereof, it can be modified, without departing from the spirit and nature of the subject invention as defined herein.

1. A track tensioning system for a tracked vehicle including a hull supporting a plurality of mid rollers, a front idler wheel, a rear idler wheel, an idler wheel, a drive sprocket, and an endless track belt trained around the mid rollers, the idler wheels and the drive sprocket, the mid rollers and the idler wheels being mounted on a rail, comprising:
a cam plate, rotatably connected to the drive sprocket on a first end thereof, and to the rail on a second end thereof; and
a member, mounted at a first end thereof to the rail and at a second end thereof to said cam plate;
wherein said member has a variable length defined between an attachment point to said cam plate and an attachment point to said rail.

2. The track tensioning system according to claim 1, wherein said member is selected in the group comprising a spring, a hydraulic cylinder and a pneumatic cylinder.

3. The track tensioning system according to claim 1, wherein the drive sprocket is a drive wheel with teeth is in driving engagement with the endless track belt in an endless path.

4. The track tensioning system according to claim 1, wherein the drive sprocket is mounted on a shaft selected in the group comprising a shaft of a motor and a chained shaft.

5. The track tensioning system according to claim 1, wherein the endless drive track is typically formed of resilient material.

6. The track tensioning system according to claim 5, wherein said resilient material is selected in the group comprising a rubber and a reinforced rubber.

7. The track tensioning system according to claim 1, wherein the endless drive track is provided with traction lugs on a first surface thereof, and with drive lugs on a second first surface thereof.

8. A track tensioning system for a tracked vehicle, comprising:
a cam plate, rotatably connected to a drive sprocket on a first end thereof, and to a rail supporting mid rollers and idler wheels of the tracked vehicle at a second end thereof; and
a member, mounted at a first end thereof to said rail and at a second end thereof to said cam plate;
wherein said dynamic member has a variable length.

9. The track tensioning system according to claim 8, wherein said member is selected in the group comprising a spring, a hydraulic cylinder and a pneumatic cylinder.

10. A track tensioning system for a tracked vehicle comprising a dynamic member supporting a sprocket of a tracked wheel of the tracked vehicle, wherein said dynamic member is forced against an endless track belt of the vehicle so as to maintain a constant tension thereof.

11. The track tensioning system according to claim 10, wherein said dynamic member is selected in the group comprising a spring, a hydraulic cylinder and a pneumatic cylinder.
